(19) United States
(12) Patent Application Publication
(10) Pub. No.: US 2007/0034800 A1
(43) Pub. Date: Feb. 15, 2007

(54) Thermal imager

(75) Inventor: Li Huang, Wuhan (CN)

Correspondence Address: SUGHRUE MION, PLLC, 2100 PENNSYLVANIA AVENUE, N.W., SUITE 800, WASHINGTON, DC, 20037, US

(73) Assignee: LI HUANG

(21) Appl. No.: 11/155,746

(22) Filed: Jun. 20, 2005

(30) Foreign Application Priority Data
Jun. 25, 2004 (CN) 200420065056.7

(51) Int. Cl. G01J 5/00

(52) U.S. Cl. 250/338.3

(57) ABSTRACT

A mobile phone like thermal imager including a housing and infrared imaging system. The housing is in a shape of a mobile phone with function keys and a display screen, a lens is on top of the housing, and a detector is positioned at an upper side of the interior of the housing. This invention provides a novel concept, competent performance, compact design, elegant appearance, light weight and ease of use.

### TECHNICAL FIELD

The present invention relates to an optoelectronic product, and more particularly to a thermal imager including an infrared imaging assembly and mobile phone-shaped housing.

### BACKGROUND

The non-refrigeration type focal plane array infrared thermal imager widely used in the market is an optoelectronic system comprising an infrared detector, optical imaging system and display. This system receives infrared energy emitted by an object by means of the photosensitive elements of the infrared detector; the detector then converts the infrared energy into electric signals. After amplifying and processing, the electric signals are converted into standard video signals which are displayed as an infrared thermal image by a Cathode Ray Tube (CRT) or Liquid Crystal Display (LCD). The thermal image corresponds with the thermal distribution on the surface of the object. Actually, compared with a visible light image, a thermal distribution image of infrared irradiation lacks level and stereo perception because the signals are weak. Therefore, in order to more effectively measure the thermal distribution of the object in practice, some auxiliary means are taken to enhance the functions.

As an infrared imaging instrument, the thermal imager has all the advantages of an infrared thermometer, such as non-contact, rapid measurement, and the capability of measuring the temperature of moving objects and tiny objects and so on. Also, the thermal imager possesses advantages such as vivid display of the temperature distribution of the object surface, high temperature resolution, multi-display methods, data storage and processing, etc. The infrared thermal imager is widely applied in the medical field, public security, fire fighting, archaeology, transportation, agriculture, geology, etc.

However, most of the thermal imagers available in the market have the disadvantages of large size, heavy weight and lack of ease to carry and operate.

### SUMMARY OF THE INVENTION

An aspect of the present invention is to overcome the above mentioned disadvantages in the conventional art and provide a novelly designed thermal imager in the shape of a mobile phone.

Thus, the present invention provides a mobile phone-like thermal imager, wherein the housing is in shape of a mobile phone with function keys and display screen; the lens is on the top of the housing, and the detector is located at the upper side of the interior of the housing.

The thermal imager according to an exemplary embodiment of the present invention has features such as the following: increased performance and usability. The invention also includes a compact design, is easy to use, light weight, cost effective and easy to carry and operate. The exemplary embodiment is also shaped similarly to a mobile phone to provide an elegant appearance and is universal, such that it could replace existing thermal imagers.

### BRIEF DESCRIPTION OF THE DRAWINGS

FIG. 1 is a structural schematic view of the thermal imager according to an exemplary embodiment of the present invention;

FIG. 2 is a left side structural schematic view of the thermal imager according to an exemplary embodiment of the present invention;

FIG. 3 is a top plan schematic view of the thermal imager according to an exemplary embodiment of the present invention;

FIG. 4 is a left side schematic view of the thermal imager according to the present invention, shown with the lid (3) in an open position;

FIG. 5 is a structural schematic view of another exemplary embodiment of the thermal imager according to the present invention; and

FIG. 6 is a back schematic view of the thermal imager according to an exemplary embodiment of the present invention.

### DETAILED DESCRIPTION OF PREFERRED EMBODIMENTS

The thermal imager according to the present invention is further described in the following description, taken in conjunction with the examples and accompanying drawings.

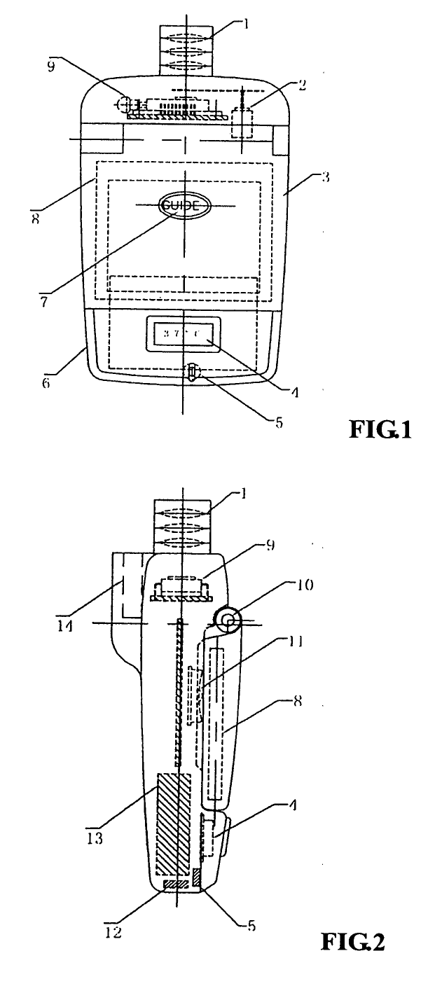

An exemplary embodiment of the present invention provides a mobile thermal imager with a structure, for example, as shown in FIGS. 1 and 2, wherein a housing is similar to a mobile phone with function keys (11) and display screen. A lens (1) is on the top of the housing and a detector (9) is positioned at an upper side of the interior of the housing.

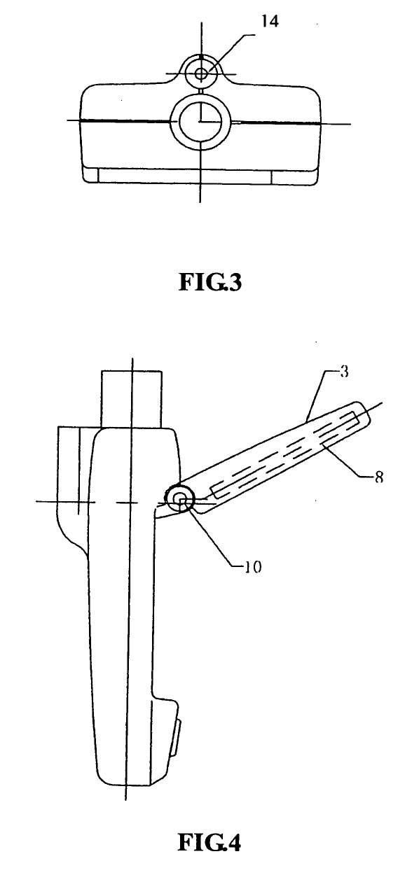

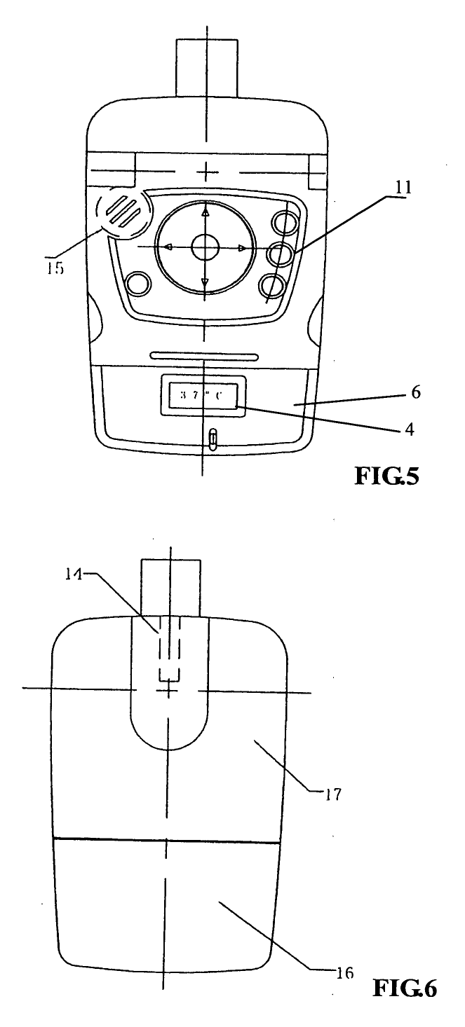

The thermal imager of the present invention may take different forms. For example, one form is similar to a folding mobile phone (shown in FIGS. 1-4), wherein the housing is equipped with a lid (3) connected to the front surface (6) of the housing by a rotator (10); and a large display screen (8) and function keys (11) are positioned on lid (3). Optionally, a small display screen (4) may be equipped on the front surface (6) of the housing. Another form is like a plate-style mobile phone (shown in FIG. 5). A large display screen (8) (not shown) and function keys (11) are positioned on the front surface (6) of the housing. A small display screen (4) may optionally be equipped on the front surface (6). The small display screen (4) can be used, for example, to display time, temperature, battery capacity, etc.

Many modules may be included in the housing such as a shutter (2), microphone (5), speaker (15), laser locator (14), voice recording device, etc. A USB interface (12) may optionally be designed on the lateral side of the housing. The shutter (2) and laser locator (14) may be at the upper side of the interior of the housing. On the back surface (17) of the housing is a battery compartment cover (16). Numerals (7) and (13) in the Figures represent brand and battery, respectively.

The working principle of the thermal imager according to the present invention may be similar to conventional thermal imagers.

The previous description of the exemplary embodiments is provided to enable a person skilled in the art to make and use the present invention. Moreover, various modifications to these embodiments will be readily apparent to those skilled in the art, and the generic principles and specific examples defined herein may be applied to other embodiments without the use of inventive faculty. Therefore, the present invention is hot intended to be limited to the embodiments described herein, but is to be accorded the widest scope as defined by the limitations of the claims and equivalents thereof.

What is claimed is:

1. A mobile phone like thermal imager comprising:
a housing in a shape of a mobile phone,
an infrared imaging system,
function keys,
a display screen,
a lens, and
a detector;
wherein the lens is on top of the housing and the detector is positioned at an upper side of the interior of the housing.

2. A mobile phone like thermal imager according to claim 1, wherein the display screen and the function keys are on a front surface of the housing.

3. A mobile phone like thermal imager according to claim 1, wherein the housing is equipped with a lid connected with the front surface of the housing, wherein the display screen is positioned on the lid and the function keys are positioned on the front surface of the housing.

4. A mobile phone like thermal imager according to claim 2, wherein the front surface of the housing is equipped with a second display screen.

5. A mobile phone like thermal imager according to claim 1, wherein the shutter is located at an upper side of an interior of the housing.

6. A mobile phone like thermal imager according to claim 5, further comprising a laser locator.

7. A mobile phone like thermal imager according to claim 5, further comprising a speaker and microphone.

8. A mobile phone like thermal imager according to claim 1 wherein the housing is equipped with a computer interface.

9. A mobile phone like thermal imager according to claim 3, wherein the front surface is equipped with second display screen.

10. A mobile phone like thermal imager according to claim 3, wherein the shutter is located at upper side of the interior of the housing.

11. A mobile phone like thermal imager according to claim 3, further comprising a computer interface.

12. A mobile phone like thermal imager according to claim 8, wherein the computer interface is a USB interface.

13. A mobile phone like thermal imager according to claim 11, wherein the computer interface is a USB interface.

14. A mobile phone like thermal imager according to claim 2, further comprising a computer interface.

15. A mobile phone like thermal imager according to claim 14, wherein the computer interface is a USB interface.

16. A mobile phone like thermal imager according to claim 2, wherein the shutter is located at an upper side of an interior of the housing.

17. A mobile phone like thermal imager according to claim 16, further comprising a laser locator.

18. A mobile phone like thermal imager according to claim 16, further comprising a speaker and microphone.

19. A mobile phone like thermal imager according to claim 3, wherein the shutter is located at an upper side of an interior of the housing.

20. A mobile phone like thermal imager according to claim 19, further comprising a laser locator.
